(19) United States
(12) Patent Application Publication
(10) Pub. No.: US 2013/0033650 A1
(43) Pub. Date: Feb. 7, 2013

(54) DISPLAY SYSTEM AND METHOD FOR PROJECTION ONTO MULTIPLE SURFACES

(71) Applicants: Ralph R. Roberts, Cottage Grove, MN (US); Brian T. Weber, Saint Paul, MN (US); Jane K. Wardhana, Woodbury, MN (US); Glenn E. Casner, Woodbury, MN (US); Brett J. Sitter, Duluth, MN (US); Patrick A. Thomas, Lake Elmo, MN (US); Steven T. Berg, Osceola, WI (US)

(72) Inventors: Ralph R. Roberts, Cottage Grove, MN (US); Brian T. Weber, Saint Paul, MN (US); Jane K. Wardhana, Woodbury, MN (US); Glenn E. Casner, Woodbury, MN (US); Brett J. Sitter, Duluth, MN (US); Patrick A. Thomas, Lake Elmo, MN (US); Steven T. Berg, Osceola, WI (US)

(73) Assignee: 3M Innovative Properties Company

(21) Appl. No.: 13/195,965

(22) Filed: Aug. 2, 2011

(51) Int. Cl. H04N 5/74; G03B 21/28

(52) U.S. Cl. 348/744; 353/69

(57) ABSTRACT

A system for projecting changeable electronic content, such as video or digital still images, onto multiple surfaces. The system includes a projector, one or more reflectors, and at least two display surfaces. The projector via a reflector projects content onto one of the display surfaces and either directly or via another reflector projects content onto the other display surface. The display surfaces can be multiple curved surfaces, multiple planar surfaces in different viewing planes, or a curved surface and a planar surface. For the curved surfaces, the projector receives converted content and projects the converted content such that the curved surface displays the converted content undistorted to a viewer. The system can also provide for display of branded content on a product container having a shape corresponding with the brand.

### BACKGROUND

Consumers have become inundated with static image content at the point of purchase. The static image content typically promotes or provides information about products in an attempt to influence consumers' purchasing decisions. However, determining the effectiveness of such static image content can be difficult. There is thus a need for new ways to attract the attention of consumers in providing them with advertisements or other product promotional content. One approach involves converting these static surfaces to video surfaces and providing video content for advertisements, attempting to attract consumers' attention through an active type of content. This video content is typically provided on flat screen display devices, such as liquid crystal display devices, proximate or near the product being promoted. The effectiveness of this type of advertisement may be limited when the consumers are simply viewing potential products to purchase and not viewing the display. Accordingly, there is a need for a new way to delivery video content, particular on curved surfaces that may resemble actual product containers.

### SUMMARY

A system for projecting changeable electronic content onto multiple curved surfaces, consistent with the present invention, includes at least two display surfaces. A projector projects electronic content to the two display surfaces, possibly by using reflectors located adjacent the display surfaces. The two display surfaces can include two curved surfaces, two planar surfaces in different viewing planes, or a curved surface and a planar surface. When at least one of the display surfaces is curved, the projector receives converted electronic content and projects the converted electronic content to the curved display surface via a reflector such that the curved display surface displays the converted electronic content undistorted to a viewer.

### BRIEF DESCRIPTION OF THE DRAWINGS

The accompanying drawings are incorporated in and constitute a part of this specification and, together with the description, explain the advantages and principles of the invention. In the drawings,

FIG. 1 is an exploded diagram of a projection system for providing changeable electronic content on a curved surface;

FIG. 2 is a diagram of exemplary components of a display surface for the projection system;

FIG. 3 is a side view illustrating a housing for the projection system;

FIG. 4 is a side sectional view of the housing for the projection system;

FIG. 5 is a top view of the housing for the projection system;

FIG. 6 is a bottom view of the housing for the projection system;

FIG. 7 is an exploded perspective view of the housing for the projection system;

FIG. 8 is a side view of an alternate embodiment of a housing for the projection system;

FIG. 9 is a diagram illustrating projection onto multiple surfaces;

FIG. 10 is a diagram of a system for projection onto two curved surfaces;

FIGS. 11A and 11B are flow charts of processes for projection onto two curved surfaces;

FIG. 12 is a diagram illustrating converted content for an embodiment of the system of FIG. 10;

FIG. 13 is a diagram of a system for projection onto two planar surfaces;

FIG. 14 is a flow chart of a process for projection onto two planar surfaces;

FIG. 15 is a diagram of a system for projection onto a curved surface and a planar surface;

FIGS. 16A and 16B are diagrams of others systems for projection onto a curved surface and a planar surface;

FIG. 17 is a flow chart of a process for projection onto a curved surface and a planar surface;

FIGS. 18A and 18B are diagrams illustrating converted and displayed content for the system of FIG. 15;

FIG. 19 is a diagram illustrating converted content for the system of FIG. 16B;

FIG. 20 is a system for projection onto a cylindrical surface and a planar surface while rotating the projector; and

FIGS. 21A and 21B are diagrams illustrating converted and displayed content for the system of FIG. 20.

### DETAILED DESCRIPTION

Embodiments of the present invention can provide a point-of-purchase (POP) projection display system where the intent is to convert static surfaces to electronic display surfaces to display video or changeable electronic still images. These surfaces can include projection onto brand specific shapes with brand specific content. Projection of video or other electronic content onto curved surfaces, particularly onto brand specific shapes, allows for new types of advertising, product promotion, and information delivery. An example of a system for projecting content onto a curved surface is described in U.S. patent application Ser. No. 13/165896, entitled “Display System and Method for Projection onto Non-Planar Surfaces,” and filed Jun. 22, 2011, which is incorporated herein by reference as if fully set forth.

The system can include a changeable electronic content source, controllers, projectors, multiple display surfaces, and appropriate reflective elements. The controller receives content from the content source and provides it to one or more projectors to be projected upon display surfaces via the reflective elements. The changeable electronic content can include electronic video content or changeable electronic (digital) still images. Each independent display surface associated with the same projector is juxtaposed so that the path length of light simultaneously delivered to each surface is similar, resulting in an in-focused image thereon. One projector can thus deliver different content to multiple display surfaces, including separate planar surfaces, curved surfaces, or combinations of curved and planar surfaces.

Projection onto Curved Surface

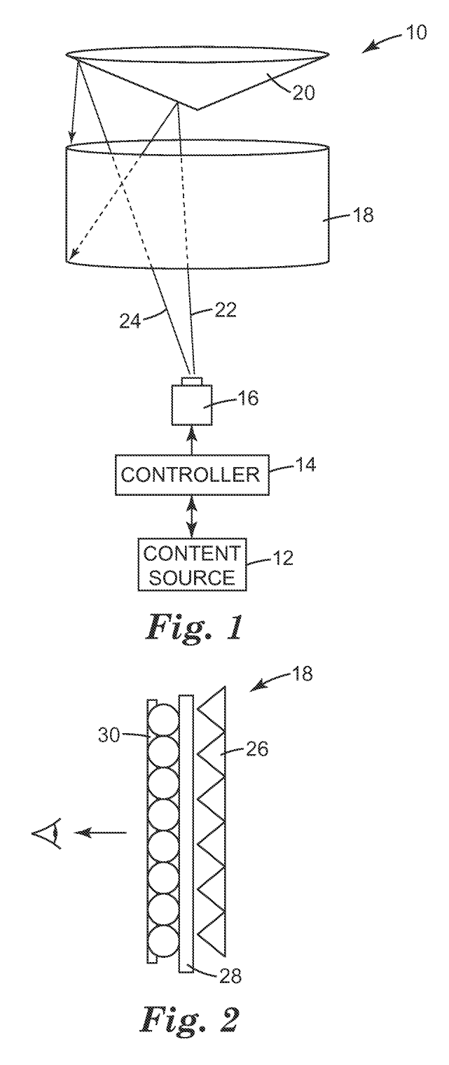

FIG. 1 is an exploded diagram of a projection system 10 for providing changeable electronic content on a curved surface. System 10 includes a content source 12, a controller 14, a projector 16, a curved display surface 18, and a conical reflector 20. Controller 14 receives content from content source 12 and provides it to projector 16 to be projected upon display surface 18 via conical reflector 20. The changeable electronic content can include electronic video content or changeable electronic (digital) still images.

Controller 14 can be implemented with a computer or other processor-based device, and content source 12 can be implemented with a memory device. Controller 14 can include a wired or wireless connection with projector 16, and it can include connections with multiple projectors for displaying content on many projection systems incorporated into different housings. Controller 14 can convert the content to be displayed, or receive content already converted. This conversion is required for curved display surface 18 to display the converted content undistorted to a viewer, meaning it displays the electronic content as it would appear on a flat display for which the original content was intended.

Conical reflector 20 preferably has a cone angle such that the projected content is uniformly displayed across display surface 18 as represented by lines 22 and 24. Conical reflector 20 can be implemented with, for example, a mirror film laminated or otherwise adhered to a substrate for mechanical support to maintain the mirror film in the desired configuration. Alternatively, the reflector can be a thermoformable mirror.

Conical reflector 20 can have a full conical mirror for projecting content onto a full 360° of curved display surface 18, as shown, or can have a partial conical mirror for projecting and displaying content on only a portion of curved display surface 18. Conical reflector 20 can optionally be curved in the axial direction in addition to the radial direction and thus resemble a convex or curve sided cone, and the reflector can optionally be a truncated cone. Also, in this embodiment any rotationally symmetric surface can be used to implement the reflector. The patent application referenced above provides a method for calculating the cone angle for the reflector in order to substantially uniformly display the converted content. Although curved display surface 18 is shown as a cylindrical surface, other types of curved display surfaces are possible, including a combination of planar and non-planar surfaces for the display surface. Also, multiple reflectors or a system of reflectors can optionally be used with the display surface.

FIG. 2 is a diagram of exemplary components of curved display surface 18 for the projection system. In this embodiment, display surface 18 includes a turning film 26, a support substrat 28, and a rear projection film (RPF) 30. As an alternative to RPF 30, other films can be used such as films having lenslet arrays, lenticular arrays, micro-Fresnel lens arrays, or micro-Fresnel lenticular arrays. Turning film 26 receives the projected content from reflector 20 and redirects the projected light to provide the content at a desired viewing angle. Support substrat 28 can be implemented with a transparent polymeric film or glass cylinder, for example, and provides mechanical support for turning film 26 and rear projection film 30. Support substrat 28 is optional in that for certain embodiments the turning film and display surface can themselves have sufficient mechanical support. The components of curved display surface 18 can be laminated or otherwise adhered together. Alternatively, the display surface can be a thermoformable screen.

Curved display surface 18 can optionally include another turning film on the viewer side of rear projection film 30. The turning films can be designed for a desired primary viewing angle for the curved display surface, for example a viewer looking directly at the display surface, up at the display surface, or down at the display surface.

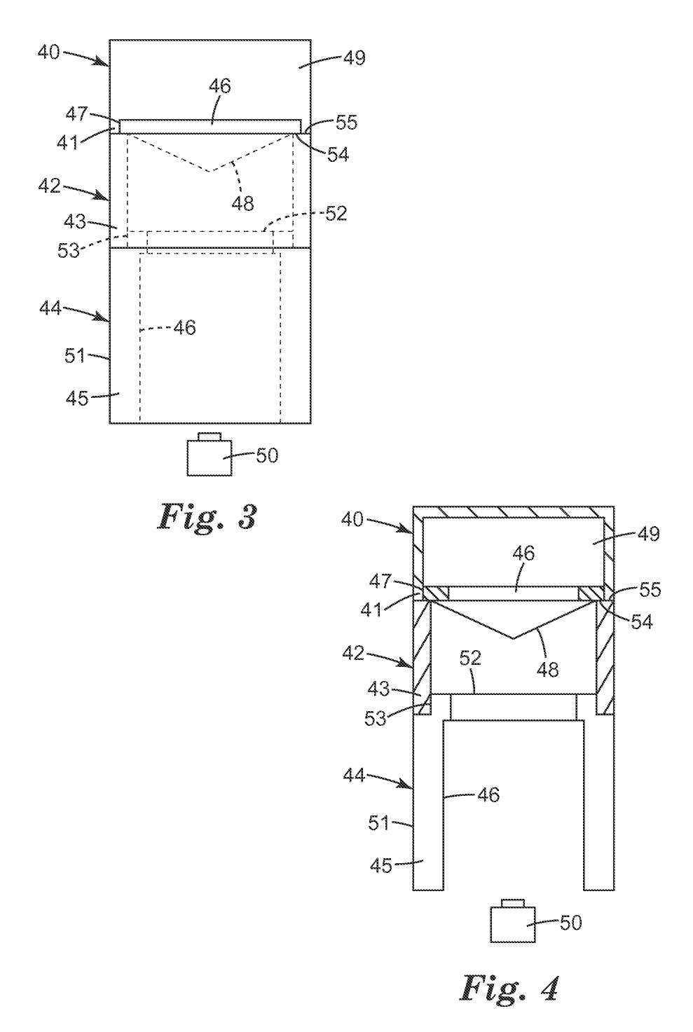

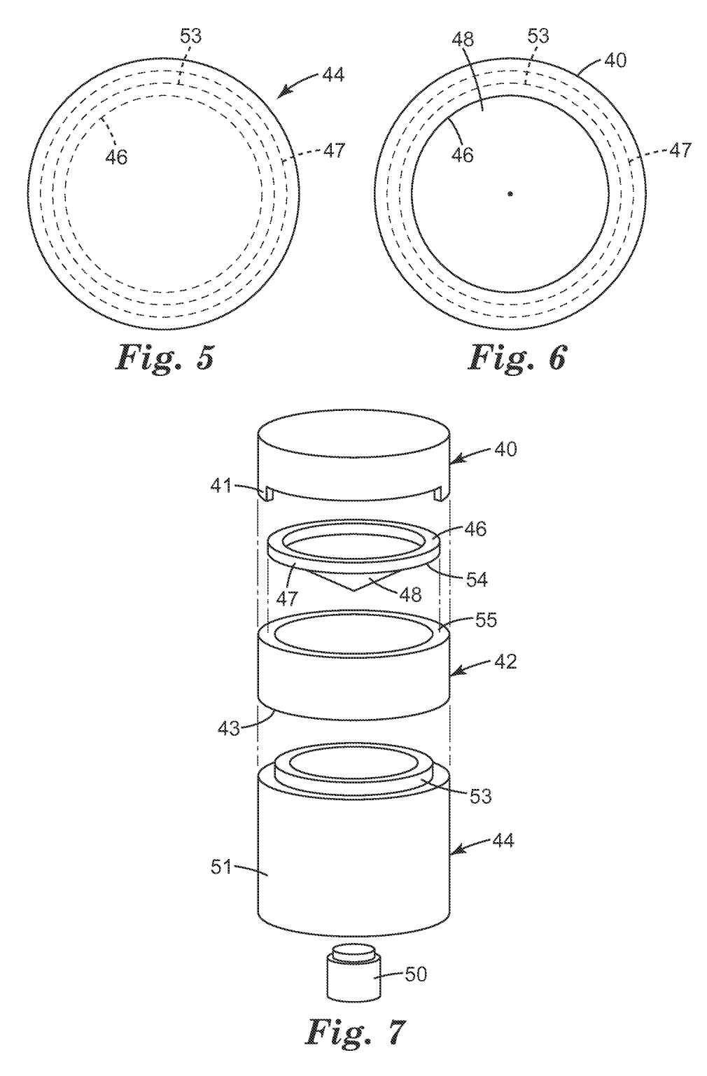

FIGS. 3-7 conceptually illustrate a housing for containing the projection system of FIGS. 1 and 2. FIGS. 3-7 are, respectively, side, side sectional, top, bottom, and exploded perspective views of the housing with the projection system. As shown in FIGS. 3-7, the housing in this embodiment includes a lid 40, curved display surface 42 corresponding with display surface 18, a base 44, and a conical reflector 48. Reflector 48 is supported by a ring 46, which has a portion 54 resting on a top edge 55 of display surface 42. Lid 40 has a bottom edge 41 that can fit against an edge 47 of ring 46 and be held in place by friction. Lid 40 also has a hollow space 49. Base 44 has a top ring 52, and a bottom edge 43 of display surface 42 can fit against an edge 53 of ring 52 and be held in place by friction. Display surface 42 also fits on top of base 44 as shown. Base 44 includes an inner wall 46, an outer wall 51, and a hollow space 45 between walls 46 and 51. Inner wall 46 of base 44 forms an aperture such that projector 50 can project content through the aperture to reflector 48 to be reflected and displayed on display surface 42 as illustrated in FIG. 1. Alternatively, the projector can be located inside the housing, and in that embodiment an aperture is not needed. The components of the housing along with the display surface can be removable, as shown in FIG. 7, or they can be fixed together using an adhesive, for example. Alternatively, the housing can be formed of a one piece enclosure, and the housing can form a complete or partial enclosure.

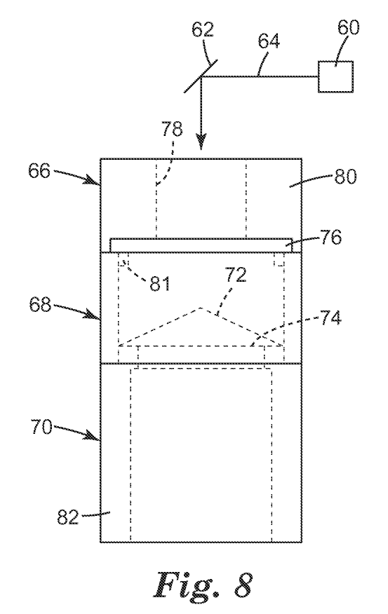

FIG. 8 is a side view of an alternate embodiment of a housing for the projection system. In this alternate embodiment, a projector 60 is located above the housing. The housing includes a lid 66, a curved display surface 68 corresponding with display surface 18, and a base 70. Lid 66 includes an aperture 78 and a hollow space 80 surrounding the aperture. A ring 76 can rest on a top edge of display surface 68 and includes a lower ring portion 81 to fit inside of display surface 68 and hold ring 76 in place by friction. Lid 66 can also rest against ring 76 and be held in place by friction. Base 70 includes a hollow space 82, similar to base 44, and also includes a ring 74. A reflector 72 is mounted on ring 74, and display surface 68 can be held in place against ring 74 by friction. In use, projector 60 projects content through aperture 78 by reflecting the content using a mirror 62 as illustrated by line 64. Mirror 62 is optional in that for certain embodiments the projector can project content directly into the housing. The projected content is reflected by reflector 72 to be displayed by display surface 68, as illustrated in FIG. 1 except in an inverse configuration. This alternate embodiment can provide for use of a ceiling mounted projector, for example.

The curved display surface can be located at a variety of locations in the housing. In FIGS. 3-8, the curved display surface is shown being located between a lid and base. However, the curved display surface can be located at a position of the lid or beneath the base. Furthermore, the height of the base and lid can be varied to change a vertical position of the curved display surface. Locating the curved display surface between a base and lid provides for a location used by many product containers for displaying labels or other static content, meaning the content displayed by the curved display surface would be in the same approximate position on the housing having an exterior surface resembling a product container as on the actual product container.

In FIGS. 3-8, the housing for the projection system is shown as a cylinder only for illustrative purposes. The housing can have a variety of three-dimensional shapes, depending upon, for example, the content to be displayed. The housing shape may correspond with a branded shape with the housing thus resembling an actual product container having a shape indicating a brand or type of product contained within it. With various housing shapes, the hollow spaces in the bases and lids can be used to contain an actual product. For example, the hollow spaces can contain a product corresponding with a branded shape of a product container resembled by the housing. In this manner, the housing can appear to be the actual product container with the product, as the aperture would not be visibly apparent through the product in the hollow spaces. In other embodiments the housing need not have hollow spaces and can instead simulate the product by being painted or having static content on it.

If the housing resembles a branded product container, the type of conversion required for the content can be selected based upon the branded shape. The controller can store conversion algorithms associated with particular branded shapes and select the algorithm required to display content undistorted on the particular branded shape. As an alternative, the controller can digitize curved display surfaces associated with particular shapes in order to select an algorithm to convert content for a particular digitized curved display surface. The digitized surface can be characterized by, for example, the parameters of size, elevation, and shape. The selected algorithm can perform pixel remapping of the content for the particular shape of the curved display surface. The content can be converted and stored for later display or converted essentially in real-time according to the algorithm.

The patent application referenced above provides exemplary materials and components for implementing the housing and projection system, although other types of materials and components can be used.

### Multi-Surface Projection

Implementation of a design method for multi-surface projection can commence with knowledge of a desired display form. Alternatively, the process can commence with surface boundaries defined by the projected rays in space from which an abstract design is shaped. Demonstrated here is a procedure where the designer starts with a known display form. Two display surfaces will be exemplified where one is flat (planar) and the other circular. The method can be extended to design configurations having multiple display screens S₁-Sₙ that are optionally curved.

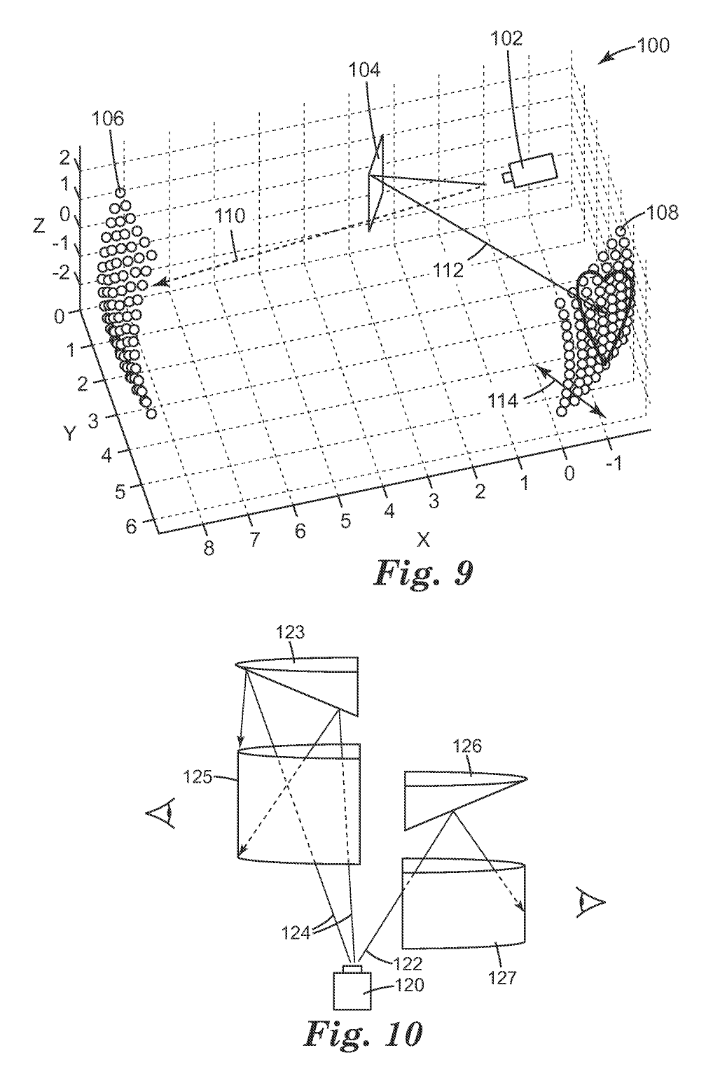

STEP 1: Determine projection optical path length to achieve the required first screen size. The design process flow starts with a determination of the projector throw distance required to provide the square area needed for the first display screen. FIG. 9 illustrates a system 100 having a projector 102 placed at a throw distance 110 (D₁) from a display screen 106 (S₁) where A′ represents the required throw area. The first display screen 106 can be optionally flat, partially spherical, partially cylindrical, partially conical, ellipsoidal, and the like. For non-flat (non-planar) screens, the system can be fitted with a corresponding non-flat mirror to deliver the desired reflection onto the screen plane. As an example, a partially cylindrical screen requires a partial cone mirror. Direct projection onto a cylindrical screen of high curvature results in poor light output in areas of high incident angles. Non-flat mirror assemblies can be implemented with, for example, a mirror film laminated or otherwise adhered to a substrate for mechanical support to maintain the mirror film in the desired configuration. Alternatively, the reflector can be a thermoformable mirror.

The optical set up delivering content to the first screen 106 can be optionally fitted with mirrors, such as a reflector 104, to “fold” the optical path. This additional feature is desirable for POP displays occupying limited space or when it is required that the projector be hidden inside of the display or otherwise hidden from view.

STEP 2: Calculate the allowed three dimensional surface for a second screen 108 (S₂) according to the position of the first screen 106 surface. For light rays that bypass the first projection screen 106, the range of placement of the second screen 108 such that the image planes of both screens are in focus is now determined. That is, for an average path length L₁ delivered to the first screen 106, the allowed three-dimensional surface for the second screen 108 is calculated. Since an assumption is that the display form factor is known, particularly targeted is the surface area in the region corresponding to the required form factor. Reflecting mirrors can be used to direct this light to the required spatial position. The screen 108 position can be further refined to a position 112 (D₂). The limit to which the second screen 108 can deviate from the optimum path length D₁ is given by the depth of field (DOF) of the projector in equation 1. The DOF in FIG. 9 is represented by line 114.

/D₂-D₁/ DOF (Equation 1)

One consideration is the DOF capability of projector technologies. Three established technologies for handheld projector systems are digital light processing (DLP, Texas Instruments Inc.), beam-steering (MicroVision, Inc.), and liquid crystal on silicon (LCOS, 3M LCOS with LCD, 3M Company). Laser video projectors are particularly advantageous projectors exemplified in embodiments of this invention because of their high DOF. Their focus-free operation allows for rapid changes in projection size, simultaneous far and near surface projection, angled projection, and projection on curved and other non-flat surfaces.

The depth of focus is the distance the focal plane may be displaced and still produce a defined level of resolution. The depth of field is the distance the image plane may be displaced and still produce a defined level of resolution. The two are related by the square of the magnification M.

M²×Depth of focus=Depth of field (Equation 2)

To compute the depth of focus limitation for the specific projector displays described herein (3M MPro 160 pico-projector), a through-focus diffraction modulation transfer function (MTF) calculation was done using the ZEMAX optical design program (Radiant ZEMAX LLC) at a reference resolution of 53 cycles/mm. This reference resolution was determined based on the pixel size of the imager. Plots were determined at several image heights and these plots then overlain. The depth of focus was determined as the distance over which the minimum response (20% response level) was maintained over all field positions. Plots of DOF as determined by this method versus the throw distance D resulted in generalized Equation 3. One should note that changing the response level or reducing the resolution requirement will produce different results than that depicted by Equation 3.

DOF=−0.0004D³+0.0275D²−0.3852D+1.5709 (Equation 3)

The configuration of projectors, mirrors and reflectors as outlined in the Examples described herein was deduced by ray tracing techniques. Ray tracing was used in the design process and was implemented using the MATLAB program (The MathWorks, Inc.). We consider all rays from the projector to originate from a point source (xₒ,yₒ,zₒ) in three-dimensional space. A direction is given to the ray as described using the symmetric Equation of a line:

$$\frac{x - {x}_{o}}{a} = \frac{y - {y}_{o}}{b} = \frac{z - {z}_{o}}{c} = t \qquad ( Equation 4 )$$

or by its parametric form:

x=xₒ+at

y=yₒ+bt (Equations 5)

z=zₒ+ct

In Equation 5 the vector [symbol] a,b,c [symbol] representing ray direction can be described as a ray of unit length along, for example, the Y-direction, given by Equation 6:

L= [symbol] (tan θ_{w},1,tan φᵢᵢ [symbol] (Equation 6)

In Equation 6, 2θ_{w} is the maximum throw angle of the projector image along, for example, the x-axis that is equivalent to the throw width of the projected image. In Equation 6, 2φₕ is the throw angle along the z-axis that is equivalent to the throw height of the image. In practice we vary the number of rays emanating from the point (xₒ,yₒ,zₒ) by stepping through the allowed values of φₕ, θ_{w}.

Our reflecting surface in FIG. 9 is defined using the equation of a plane:

Ax+By+Cz+D=0 (Equation 7)

where N=(A,B,C) is the normal vector to the plane and a point P (xP, yP, zP) lies on the plane.

To find the point of intersection, P, between the ray and plane, we find the value oft at the point P; that is we substitute the parametric equations into the equation of the plane and solve for t:

A(xₒ+at)+B(yₒ+bt)+C(zₒ+ct)+D=0 (Equation 8)

The value oft is then substituted back into the parametric equations to give the coordinates P(x_{P}, y_{P}, z_{P}).

To determine the angle a that the ray vector represented by Equation 6 makes with the plane we use the Equation 9:

$$cos α = \frac{N \cdot L}{‖ N ‖ ‖ L ‖} \qquad ( Equation 9 )$$

where N, L are as defined above and “.” represents the dot product. It can be shown that for a vector i striking a plane at an incident angle a , the reflected ray vector is given by:

r=i−2 cos(α)n (Equation 10)

where all are unit vectors and n is the normal vector to the plane at the point of incidence. To summarize FIG. 9, rays leaving the projector 102 arrive at screen location 106 where a focused image is established. The screen size is determined according to the throw angles 2φₕ,2θ_{w} as stated above. Rays that impinge on mirror 104 are mapped to a location 108, again the size of which is determined by the limitation 2φₕ, 2θ_{w}. Finally, we can vary the position of screen 108 according to Equation 3 to maintain a focused image.

STEP 3: Reduce the area of the second screen 108 surface to an actual display shape. With the orientation of the second screen 108 determined, the projected area at this position is configured to provide the desired form. FIG. 9 shows the second display screen 108 reduced to a heart-shaped display as an example.

STEP 4: Optimize the projection screens with prism turning films and image directing films. The projection screens 106 and 108 are to be optimized for high luminous output. This optimization involves directing the light rays impinging from the projector to within an acceptable acceptance angle φₒ to the screen (see the patent application referenced above). Useful examples of projection surfaces include the VIKUITI projection screens (3M Company). These screens provide optimized gain control and front face ambient light rejection resulting in good contrast. The screen is characterized by its light acceptance angle of ±15° corresponding to ≧50% of maximum screen brightness. The screen can be modified with image turning prism film options that aid in the delivery of light to within the required ±15° limit resulting in adequate display brightness. The image turning film can be optimized to direct light toward the RPF at the desired angle φₒ as described in the application reference above. In one embodiment, the image turning film has a variable pitch resulting in uniform image brightness of the screen surface. Alternative modifications to the RPF are within the scope of embodiments of this invention and include combinations of RPF comprising lenslet arrays, lenticular arrays, micro-Fresnel lens arrays, or micro-Fresnel lenticular arrays.

STEP 5: Content generation. The motion or still image video content for screens S₁-Sₙ are to be optimized for viewing in a undistorted manner.

The details for projecting imagery onto a 360°-view cylindrical surface via a cone mirror has been detailed in the patent application referenced above and is provided here as an example. One skilled in the art can customize the video content described therein for displays comprising partial mirrors and corresponding partial screen surfaces. The steps of customizing such content for a display comprising screens S₁-Sn where S₁ is a partial cylindrical screen include the following steps: importing the video content onto the timeline of a standard video editing software system such as the FINAL CUT PRO program (Apple Inc.); cropping away the digital content that overlaps with screen areas designated for S₂-Sₙ; and overlaying video content on separate video tracks for screens S₂-Sₙ. This approach is exemplified below.

Content for other combinations of shaped screens and corresponding shaped reflectors can also be realized. Specific examples of display surfaces for which pixel mapping routines can be realized include partially spherical, partially cylindrical, partially conical, ellipsoidal surfaces, and the like.

Projection onto Multiple Curved Surfaces

FIG. 10 shows an exploded view for a display comprising a projector 120, partial cone mirrors 123 and 126, and two curved display screens 125 and 127. The projector 120 delivers a portion of its rays to the first curved mirror 123 which are reflected to the first display screen 125. Rays that bypass the first mirror impinge onto the second cone mirror 126 and then onto the second display screen 127. The display system can be adjusted so that the digital content delivered to screens 125 and 127 are simultaneously focused.

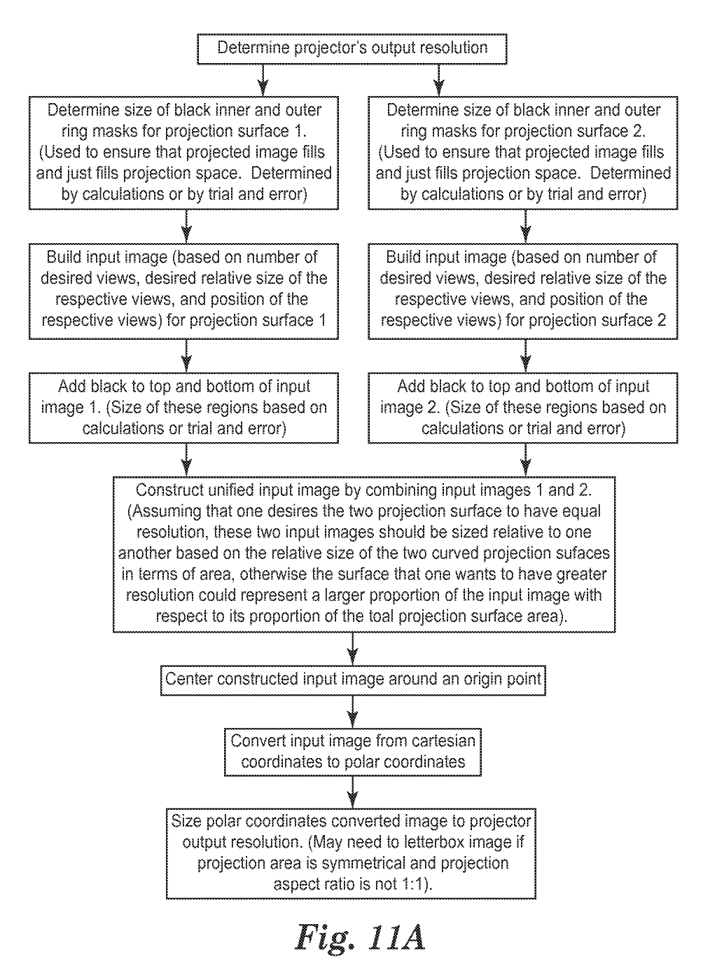

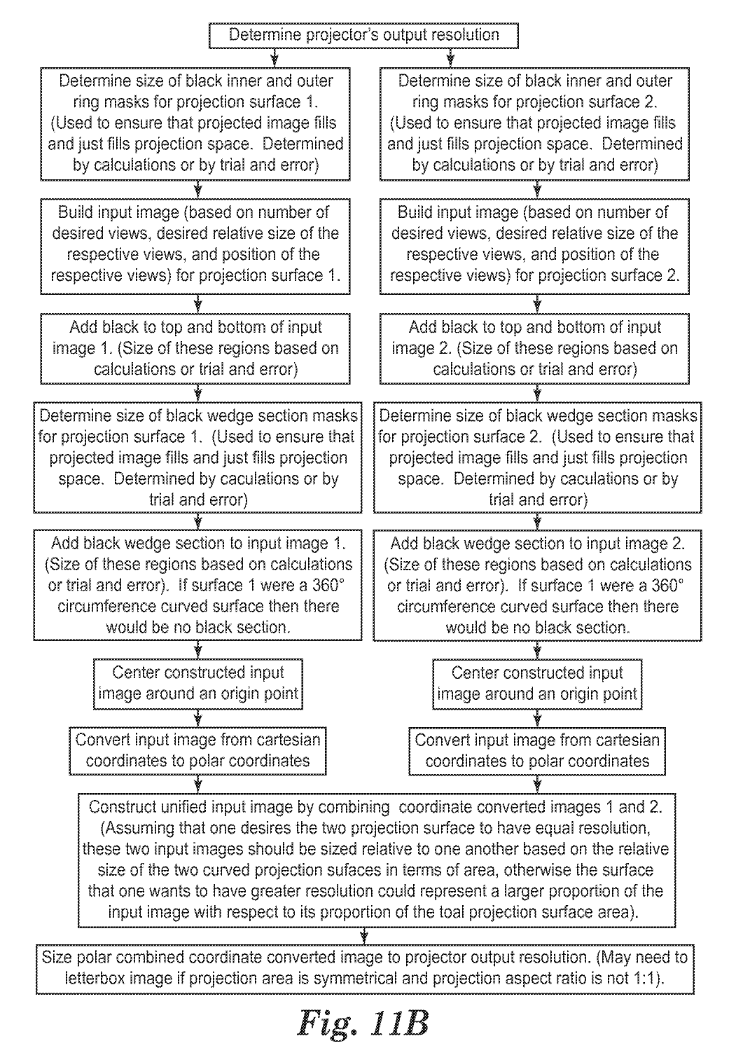

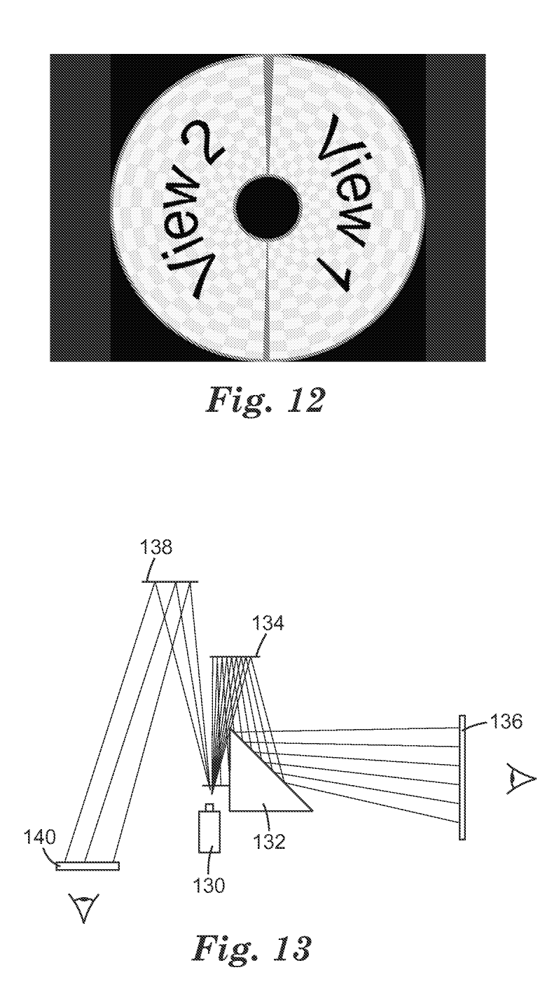

FIG. 11A is a flow chart of a process for projecting content onto two curved surfaces where each curved surface is 180° or less. FIG. 1 lB is a flow chart of a process for projecting content onto two curved surfaces where each curved surface greater is than 180°. FIG. 12 is a diagram illustrating converted content for an embodiment of the system of FIG. 10. In particular, this illustrated converted content corresponds to display on two curved surfaces where the surfaces together provide for a 360°-view surface with View 1 and View 2 representing converted content for each 180°-view screen, together providing a 360°-view surface.

Projection onto Multiple Planar Surfaces

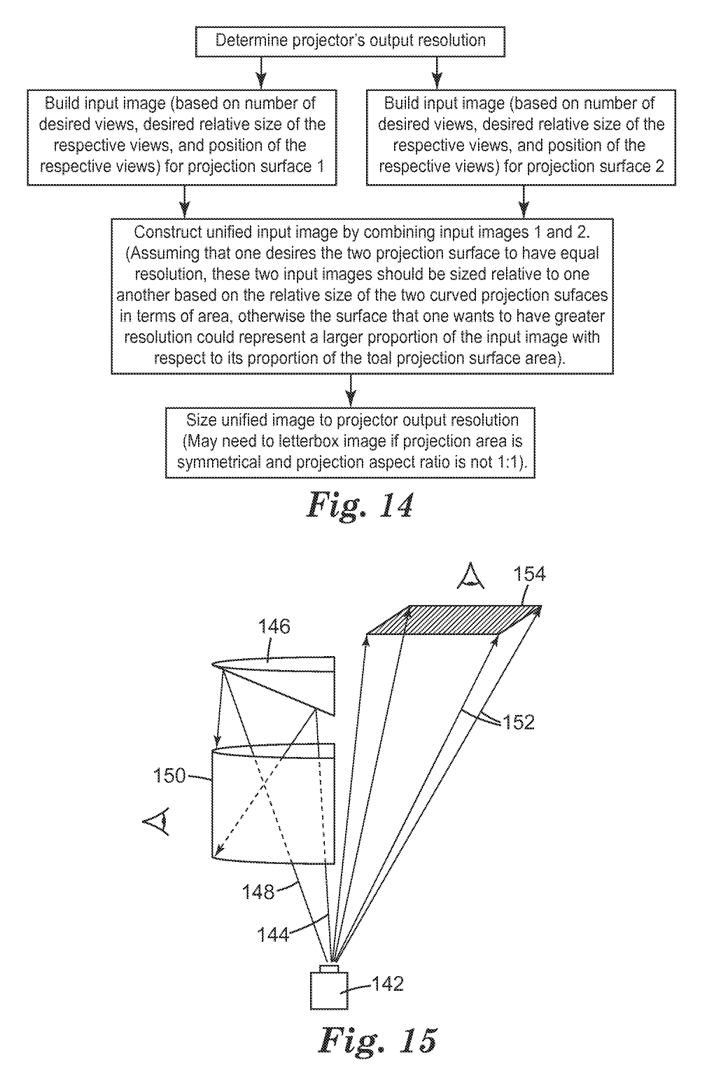

FIG. 13 is a diagram of a system for simultaneous projection onto two planar surfaces where the display surfaces are in different planes of view. Furthermore, FIG. 12 illustrates an example of a folded optics set-up for display on two planar surfaces having a projector 130, reflectors 132, 134, and 138, and display surfaces 136 and 140. Projector 130 projects content to reflectors 134 and 138. Reflector 138 projects a portion of the content from projector 130 to display surface 140. Reflectors 132 and 134 project another portion of the content from projector 130 to display surface 136. The folded optics set-up provides for projection onto display surfaces in different planes, in this example display surfaces perpendicular to one another, although other orientations of two or more display surfaces can be used. FIG. 14 is a flow chart of a process for projecting content onto two planar surfaces;

Projection onto Curved and Planar Surfaces

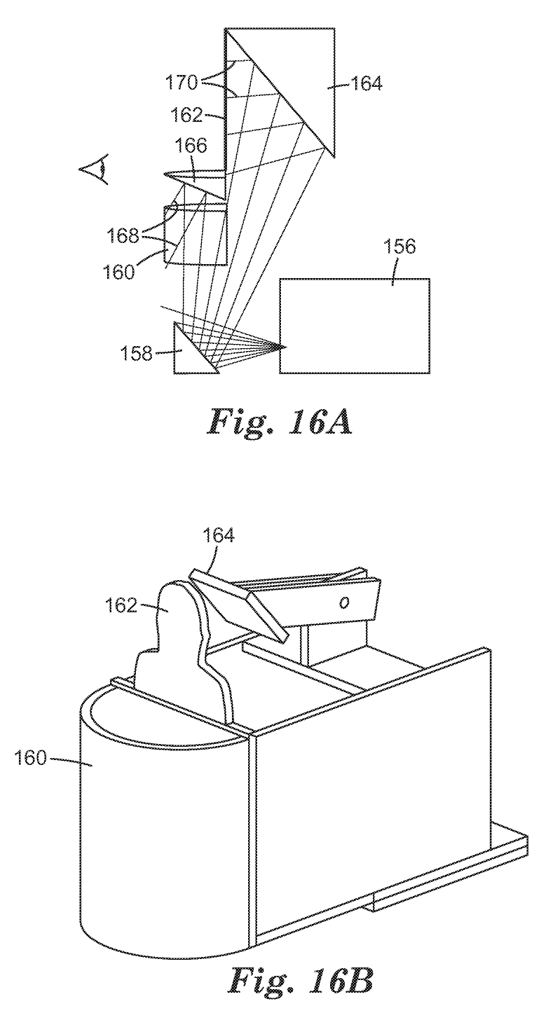

FIGS. 15, 16A, and 16B are diagrams of systems for simultaneous projection onto a curved surface and a planar surface.

FIG. 15 shows an exploded view of a projector 142 configured with a 180° section of a cone mirror 146, a curved display surface 150, and a planar display surface 154. The assembly can be configured so that light rays 144 and 148 striking the curved 180°-view surface 150 are of similar light path length to rays 152 striking the planar surface 154. The display surface 150 is optimized for viewer visibility by use of screen construction of FIG. 2 where the turning film on the projection side of the screen turns the rays 144 and 148 into an acceptable light angle to the RPF.

Display articles, and in particular POP articles, suitable for the optical set-up in FIG. 15 include cylindrical-like articles having accessible top and curved faces. Without limitation these include cans (e.g., paint cans, soup cans, or other foodstuff cans), barrels, tubular containers, kegs, cups, vases, and the like.

FIG. 16A is a side view of a display comprising a projector 156, planar reflectors 158 and 164 and a 180° cone mirror 166. Surfaces 160 and 162 are vertical 180°-curved and planer display screens, respectively. Light rays 168 reflected off the planar reflector 158 impinge onto the curved surface 166 and then onto the 180° curved screen 160. Light rays 170 that bypass the cone mirror 166 strike the top planar reflector 164 and are reflected onto the planar screen 162. Configurations where either or both viewing surfaces are not entirely vertical but viewable from the vertical plane are possible. The use of a vertical 180°-view and planar screens is one particular embodiment.

An application of the system of FIG. 16A can include a cut-out for the vertical screen 162 with a combination 180°-view screen, as illustrated in the perspective view of FIG. 16B. Systems for projection of content onto a cut-out, or a screen defining a shape as illustrated in FIG. 16B, are describe in U.S. Pat. No. 7,923,675 and U.S. Patent Application Publication No. 2011/0075114, both of which are incorporated herein by reference as if fully set forth.

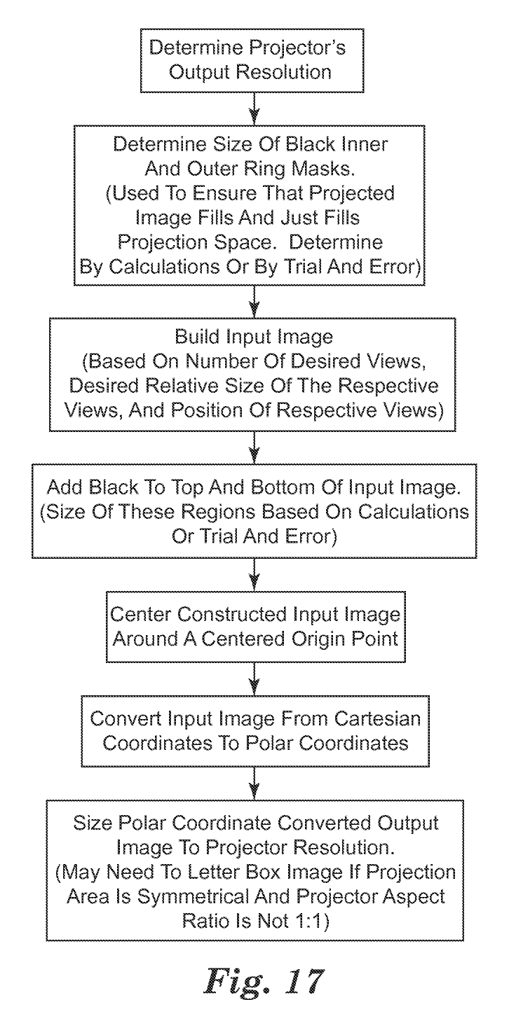

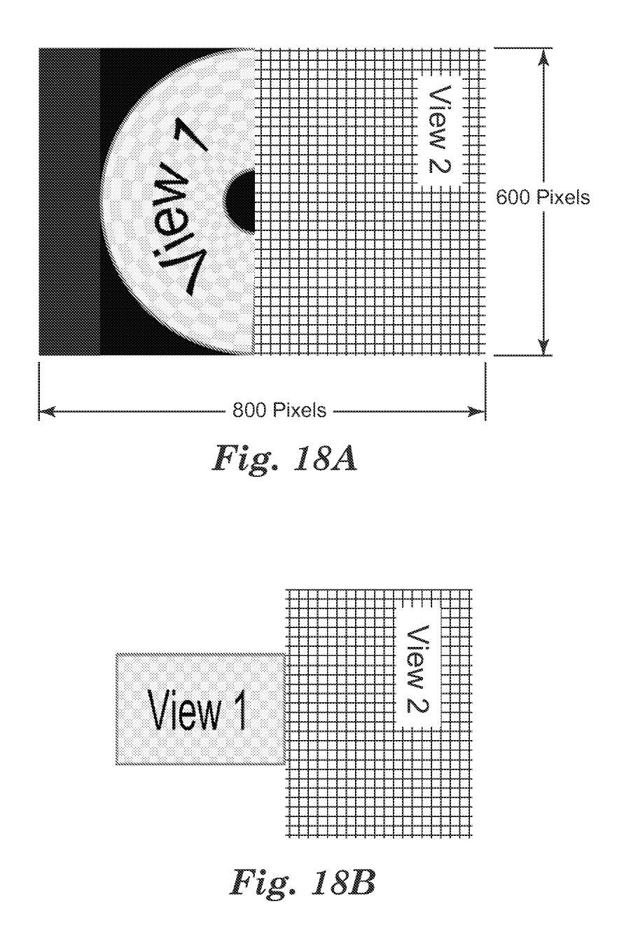

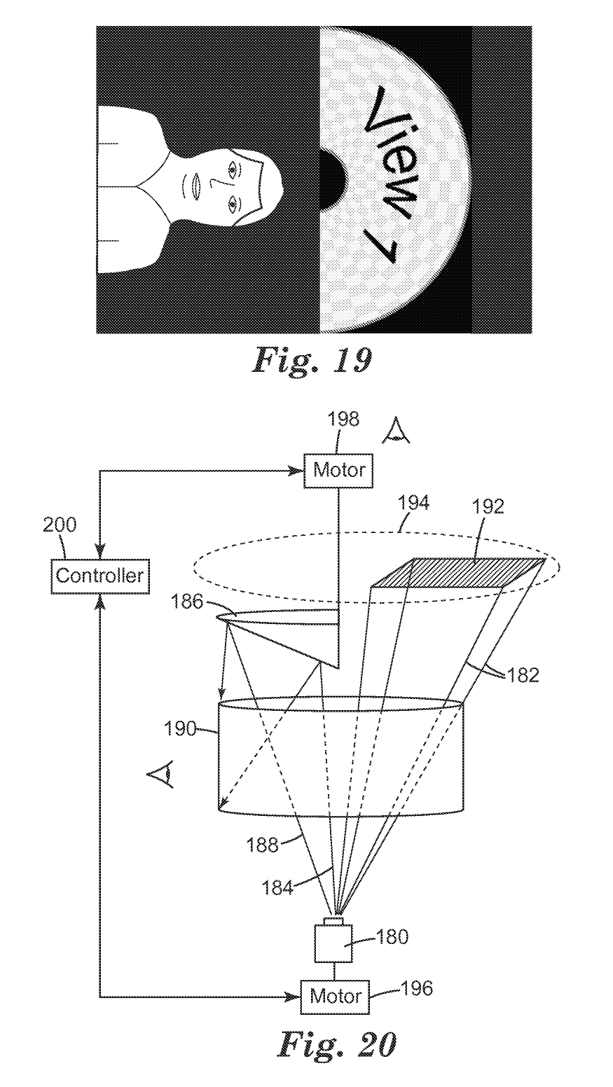

FIG. 17 is a flow chart of a process for projecting content onto a curved surface and a planar surface. FIGS. 18A and 18B are diagrams illustrating converted and displayed content for projection for the system of FIG. 15. In FIG. 18A, View 1 represents the converted content for display on curved display surface 150, and View 2 represents the content for display on planar display surface 154 and not requiring conversion. In FIG. 18B, Views 1 and 2 represent how the content would appear on display surfaces 150 and 154, respectively. FIG. 19 is a diagram illustrating converted content for the system of FIG. 16B for a cut-out screen displaying an image of a person, for example. In FIG. 19, View 1 represents the converted content for display on curved display surface 160, and the left view represents the content for display on planar display surface 162 when implemented as a cut-out as show in FIG. 16B.

Variations of the optics set-up of FIGS. 15, 16A, and 16B include reconfiguring screen 162 so that both screens are curved. Useful display articles of the optical set-up in FIGS. 15, 16A, and 16B include, but are not limited to, a POP peg-board in a retail store, a tabletop display in a restaurant or bar environment, tiered cakes, stacked cylinders (e.g., a stacked canned goods), and the like.

Rotating Projection onto Curved and Planar Surfaces

The display system shown in FIG. 15 can be modified to include a 360°-view display surface, instead of the 180°-view surface, and a circular screen area for the planar display surface. Such modification also includes providing motor and shaft assemblies to synchronously rotate the projector and semi-conical reflector.

FIG. 20 shows an exploded view for a display comprising a projector 180, partial cone mirror 186, a 360°-view screen 190, and a planar circular screen 194. The projector 180 and partial cone mirror 186 are affixed to the axle of a motor shaft 196 and 198, respectively, controlled by a controller 200. The cone mirror is configured for synchronous movement with the projector. In particular, operation of the motors causes the projected system of rays 184 and 188 to systematically project onto different portions of the 360°-view screen 190 according to the special position of the reflector. Simultaneously, the projected rays 182 provide moving imagery on the screen 194 in a display area 192. As an alternative to two synchronously operating motors, the system can use one motor with a mechanical linkage connected to both the projector and cone mirror to synchronously rotate them.

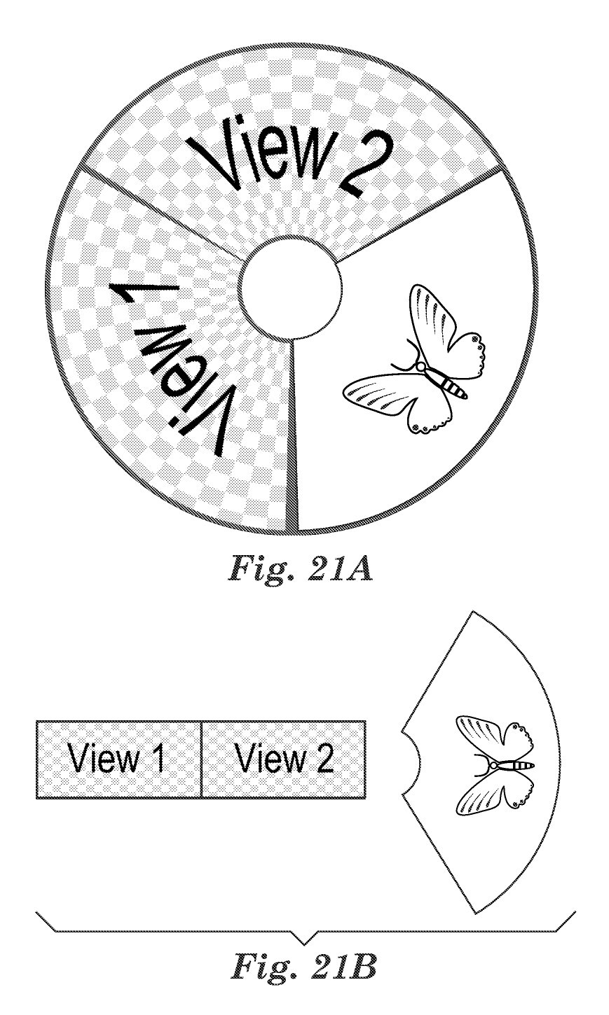

FIGS. 21A and 21B are diagrams illustrating converted and displayed content for the system of FIG. 20. FIG. 21A shows the partitioning of the 800×600 pixel area of the 3M MPro 160 pico-projector to provide video content for the optical set-up of FIG. 20 where the cone mirror 186 is 240°. The 800×600 pixel area of the projector is segmented into a circular inner video region. This is further subdivided into three 120° segments. Areas View 1 and View 2 in FIG. 21A represent independent video content display areas to be projected onto the 240° cone mirror 186. Pixel remapping as described in the flow chart of FIG. 17 provides the video content for View 1 and 2 areas.

View 3 area of FIGS. 21A and 21B, a butterfly in this example, comprises video content that is directly projection onto the planar view screen 192 and therefore no distortion algorithm is applied to that video section. Registering of video content of areas View 1 and View 2 with the 240° cone mirror and operation of the motors causes the content to be displayed on the screen surface 190 as a 360°-view display. Simultaneously, the video content of area View 3 is displayed as a rotating image on screen 194 in the plane of display area 192. FIG. 21B shows how the display images appear on the device of FIG. 20. In particular View 1 and View 2 images appear on the curved display area as they would on a flat surface, in an undistorted manner, and View 3 appears as an image rotating on a planar circle.

Display articles, and in particular POP articles, suitable for the optical set-up in FIG. 20 include cylindrical-like articles having accessible top and curved faces. Without limitation these include cans (e.g., paint cans, soup cans, and other foodstuff cans), barrels, tubular containers, kegs, cups, vases, and the like. Other POP display applications include a ceiling mounted hoop display where the 360°-view surface is particularly advantageous for customer viewability as well as a flat bottom surface.

The various multi-surface projection systems shown in FIGS. 10, 13, 15, 16A, 16B, and 20 typically include housings for containing the display surfaces, as conceptually illustrated in FIGS. 3-8. For example, the curved display surface can be at least a portion of display surface 42, and the planar display surface can be at least a portion of lid 40 (see FIG. 7). Other configurations of multi-surface displays are possible depending upon, for example, the shape of a particular product container. The housings may also correspond with branded shapes, for example. Exemplary components and materials for multi-surface projection systems are provided in the Examples and the patent application referenced above. Furthermore, in any of the embodiments described above the individual reflectors can be implemented with portions of the same reflector.

The exemplary algorithms in the flow charts of FIGS. 11A, 11B, 14, and 17 for pixel remapping for image conversion can be stored in software or firmware and executed by the controller. Alternatively, the algorithm can be stored in hardware, such as a custom integrated circuit chip, or a combination of hardware and software.

### EXAMPLES

### Example 1

Point of purchase paint can display comprising a projector configured with one curved reflecting surface and two receptacle screens.

The display fabrication was achieved by re-configuration of a commercial novelty acrylic paint can (Stampendous plastic pail with tin handle and trim, distributed by Amazon.com). The external dimensions of the can were 17.0 cm diameter×18.0 cm high. A circle of diameter 3 inches was cut out of the base of the can to provide a pass through for rays from the projector. A commercial 3M MPro160 pico-projector was used as the video source for the display. The projector was fitted with a Sony VCL-DH0730 wide angle 30 mm lens.

The configuration shown in FIG. 15 was used to provide the display. The paint can was fitted with a 180° cone mirror 146. This was made from a shaped circular sheet of Enhanced Specular Reflector (ESR) film (3M Company) of diameter 16.6 cm. This film was glued using 3M SCOTCH ATG double sided tape to give a cone of height 2.2 cm and base angle 16°. The glued cone was then adhered to a acrylic disk. The cone and disk were then cut in half to provide the required 180° cone mirror 146. This was adhered to the inner surface of the paint can a distance of 13.4 cm from the base of the can with 3M SCOTCH-WELD DP-100 epoxy adhesive (3M Company).

The screen area 150 was constructed according to the design of FIG. 2. The inner surface of the can was lined with 60° prism turning film using 3M optically clear adhesive (3M Company). The outer surface are of the display area 150 was covered with the beaded RPF screen using 3M SCOTCH ATG double sided adhesive transfer tape (3M Company). The lid area was fitted with a semi-circular sheet of RPF to give the projected area 154. With this configuration, rays 144 and 148 striking the curved surface 150 were of path length 22.7 cm-30.1 cm, and rays 152 striking the surface 154 were of path length 25.5 cm-26.8 cm. We saw that there was an overlap of optical path length distances. This overlap of optical path lengths coupled with the depth of focus limitation of Equation 3 allowed for simultaneous projection of focused imagery on surfaces 150 and 154.

FIG. 18A depicts how the 800×600 pixel output of the projector can be manipulated for the display of FIG. 15. View 1 of FIG. 18A was achieved according to the pixel remapping algorithm of FIG. 17. View 2 of FIG. 18A was achieved from standard video content that was rotated through 90°.

### Example 2

Point of purchase mannequin display comprising a projector, a partial cone mirror, a 180°-view curved screen surface and a planar screen surface where both viewing screens are vertical.

A display was constructed according to the configuration of FIG. 16B. The mirror 158 had a base angle of 49°. The top mirror 164 had a base angle of 50°. The projector 156 was positioned 1.6 inches from the lower edge of mirror 158. The cone mirror 166 had a base angle of 16°. The outer diameter of the curved mirror 166 and screen assembly 160 was 11 cm. Projection onto the display system gave light rays 168 of path length 8.1 inches -8.9 inches and rays 170 of path length 8.1 inches-9.1 inches. We saw that there was an overlap of optical path length distances. This overlap coupled with the DOF restriction (Equations 1 and 3) allowed for the simultaneous projection of focused imagery on display surfaces 160 and 162.

Two video tracks were combined to provide the content for the mannequin display. The first video track was that of the digital mannequin, which is to be projected onto the planar cut-out surface 162. The second video content was to be projected onto the curved surface 160. The pixel remapped content of FIG. 18A, a 800 wide×600 high pixel image was imported onto the timeline V3 of the video editing software FINAL CUT PRO (Version 5.1.4; Apple Inc.). The content was adjusted by cropping away the left 400 wide×600 high pixel area leaving a pixel area of 400 wide×600 high. Onto the video track V2 was placed the video content for the mannequin speaker on display surface 162. The video frames were rotated 90° clockwise and offset so that they overlapped with the deleted pixel area of the video track V3. A test JPEG still image of the composite overlaid images (800×600 pixel dimension) was exported from the timeline and projected onto the mannequin display via the 3M MPro 160 pico-projector. The video content of video tracks V2 and V3 were then adjusted (scaled, center point offset) according to this projected composite image. This process was repeated until an exported composite image when projected onto the video display was aligned with the respective screens 160 and 162. FIG. 19 is an example of an exported composite image. When projected onto the display, the projected mannequin profile was aligned with the cut-out screen 162.

1. A system for projecting changeable electronic content onto multiple curved surfaces, comprising:
a first curved display surface;
a second curved display surface;
a first reflector located proximate the first curved display surface;
a second reflector located proximate the second curved display surface; and
a projector located for projecting electronic content to the first and second reflectors,
wherein when the projector receives converted electronic content and projects first and second portions of the converted electronic content to the first and second reflectors, the first curved display surface displays the first portion of the converted electronic content undistorted to a viewer and the second curved display surface displays the second portion of the converted electronic content undistorted to a viewer.

2. The system of claim 1, wherein the first and second reflectors each comprise a partial cone.

3. The system of claim 1, wherein the first and second curved display surfaces each comprise:
a support substrate;
a rear projection film; and
a turning film.

4. The system of claim 1, wherein the changeable electronic content comprises electronic video content.

5. The system of claim 1, wherein the changeable electronic content comprises changeable electronic still images.

6. A system for projecting changeable electronic content onto multiple planar surfaces, comprising:
a first planar display surface;
a second planar display surface;
a first reflector located proximate the first planar display surface;
a pair of reflectors located proximate the second planar display surface; and
a projector located for projecting electronic content to the first reflector for displaying a first portion of the electronic content on the first planar display surface and to the pair of reflectors for displaying a second portion of the electronic content on the second planar display surface,
wherein the first planar display surface is in a different viewing plane from the second planar display surface.

7. The system of claim 6, wherein the changeable electronic content comprises electronic video content.

8. The system of claim 6, wherein the changeable electronic content comprises changeable electronic still images.

9. The system of claim 6, wherein the second planar display surface is perpendicular to the first planar display surface.

10. A system for projecting changeable electronic content onto curved and planar surfaces, comprising:
a first curved display surface;
a second planar display surface;
a reflector located proximate the first curved display surface; and
a projector located for projecting electronic content to the reflector and to the second planar display surface,
wherein when the projector receives a electronic content having a converted portion and an unconverted portion and projects the converted portion to the reflector while projecting the unconverted portion to the second planar display surface, the first curved display surface displays the converted content undistorted to a viewer and the second planar display surface displays the unconverted content.

11. The system of claim 10, wherein the reflector comprise a partial cone.

12. The system of claim 10, wherein the first curved display surface comprises:
a support substrate;
a rear projection film; and
a turning film.

13. The system of claim 10, wherein the changeable electronic content comprises electronic video content.

14. The system of claim 10, wherein the changeable electronic content comprises changeable electronic still images.

15. The system of claim 10, wherein the first curved display surface is in a different viewing plane from the second planar display surface.

16. The system of claim 10, wherein the first curved display surface is in a same viewing plane as the second planar display surface.

17. The system of claim 10, further comprising a planar reflector located proximate the second planar display surface, wherein the projector projects the unconverted portion to the second planar display surface via the planar reflector.

18. A system for projecting rotating changeable electronic content onto curved and planar surfaces, comprising:
a first curved 360°-view display surface;
a second planar display surface;
a partial cone reflector located proximate the first curved display surface; and
a projector located for projecting electronic content to the reflector and to the second planar display surface,
wherein the projector and the partial cone reflector are each rotatable, and the partial cone reflector is configured to synchronously rotate with the projector,
wherein when the rotating projector receives a electronic content having a converted portion and an unconverted portion and projects the converted portion to the synchronously rotating reflector while projecting the unconverted portion to the second planar display surface, the first curved display surface displays the converted content undistorted to a viewer and the second planar display surface displays the unconverted content.

19. A process for projecting changeable electronic content onto multiple surfaces, comprising:
partitioning a projector's luminous output to provide a first projected in-focus image plane and a remaining luminous output;
segmenting the remaining luminous output to separate spatial focal planes such that the focal planes are within a depth of field of the first projected in-focus image plane;
segmenting electronic video content of the projector to match a spatial arrangement of first and second projection screens; and
applying a pixel remapping algorithm to the video content so that the projected electronic video content projected to the first and second projection screens appears undistorted to a viewer.

20. The process of claim 19, wherein the projector is a laser-based projector.
